(19) United States
(12) Patent Application Publication
(10) Pub. No.: US 2019/0073298 A1
(43) Pub. Date: Mar. 7, 2019

(54) MEMORY MANAGEMENT METHOD, MEMORY CONTROL CIRCUIT UNIT AND MEMORY STORAGE APPARATUS

(71) Applicant: PHISON ELECTRONICS CORP., Miaoli (TW)

(72) Inventors: Sheng-Han Wang, Taichung City (TW); Hoe-Mang Mark, Miaoli County (TW)

(73) Assignee: PHISON ELECTRONICS CORP., Miaoli (TW)

(21) Appl. No.: 15/798,412

(22) Filed: Oct. 31, 2017

(30) Foreign Application Priority Data
Sep. 5, 2017 (TW) 106130253

(51) Int. Cl. G06F 12/02; G06F 12/12

(52) U.S. Cl. CPC G06F 12/0269; G06F 2212/702; G06F 12/12

(57) ABSTRACT

A memory management method, and a memory control circuit unit and a memory storage apparatus using the same are provided. The method includes associating physical erasing units with a data area or a spare area, configuring a plurality of logical addresses for mapping to the physical erasing units, and obtaining a garbage collection threshold based on a plurality of valid logical addresses among the logical addresses, and the physical erasing units mapping to the valid logical addresses are associated with the data area. The method further includes performing a garbage collection operation on the data area if the number of the physical erasing units associated with the data area is no less than the garbage collection threshold.

### CROSS-REFERENCE TO RELATED APPLICATION

This application claims the priority benefit of Taiwan application serial no. 106130253, filed on Sep. 5, 2017. The entirety of the above-mentioned patent application is hereby incorporated by reference herein and made a part of this specification.

### BACKGROUND

### Technical Field

The invention relates to a memory management method for a rewritable non-volatile memory, and a memory control circuit unit and a memory storage apparatus using the method.

### Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., a flash memory) ideal to be built in the portable multi-media devices as cited above.

A flash memory module has a plurality of physical erasing units, and each of the physical erasing units has a plurality of physical programming units. Also, data must be written into the physical erasing unit according to a sequence of the physical programming units. Further, the physical programming units already written with data must be erased before they can be used again for writing data. In particular, the physical erasing unit is a minimum unit for erasing, and the physical programming unit is a minimum unit for programming (a.k.a. writing).

After an initialization operation of a memory storage apparatus is completed in management of the flash memory module, a memory management circuit will assign empty physical erasing units to a spare area. When performing a write command from a host system, the memory management circuit selects a specific physical erasing unit from the spare area, writes user data from the host system into that specific physical erasing unit and associates that specific physical erasing unit to a data area (e.g., by recording mapping information between logical pages and physical programming units in a logical address-physical address mapping table). During operation of the memory storage apparatus, with the write command given by the host system, the user data will be updated and the physical erasing units not storing valid data will be re-associated with the spare area. Thus, the physical erasing units are continuously used in alternate manner for writing the user data.

Given that the physical erasing units are continuously used in alternate manner, the memory management circuit needs to reserve a specific number of physical erasing units so the writing operation may be performed smoothly. Therefore, the memory management circuit will monitor the number of the physical erasing units used in the data area and accordingly perform a garbage collection operation (a.k.a. a valid data merging operation) in order to prevent the physical erasing units of the spare area from running out. For example, when the number the physical erasing units of the spare area is insufficient, the memory management circuit will perform the garbage collection operation on the physical erasing units of the data area so the valid data on several physical erasing units can be collected to an empty physical erasing unit and the physical erasing unit no longer storing the valid data can be re-associated with the spare area. By doing so, the number of the physical erasing units of the spare area may be increased. In particular, in a case where a random read operation is repeatedly performed on certain logical addresses by the host system so physical blocks of the flash memory module are almost fully written, if the host system then gives a sequential write command, the memory management circuit needs to constantly perform the garbage collection operation before proceeding to handle the sequential write command. Execution of the garbage collection operation will take quite some time, resulting in a serious delay on the time for performing the sequential write command. Therefore, how to effectively perform the garbage collection operation is still one of the major objective for persons skilled in the art.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The invention provides a memory management method, a memory storage apparatus and a memory control circuit unit, which are capable of effective performing the garbage collection operation and improving a performance of the memory storage apparatus.

An exemplary embodiment of the invention provides a memory management method for a rewritable non-volatile memory module. The rewritable non-volatile memory module has a plurality of physical erasing units. The memory management method includes associating the physical erasing units at with a data area or a spare area, and configuring a plurality of logical addresses for mapping to the physical erasing units;

and obtaining a garbage collection threshold based on a plurality of valid logical addresses among the logical addresses, wherein the physical erasing units mapping to the valid logical address are associated with the data area. The memory management method further includes performing a garbage collection operation on the data area when the number of the physical erasing units associated with the data area is no less than the garbage collection threshold.

An exemplary embodiment of the invention provides a memory control circuit unit configured to control a rewritable non-volatile memory module. The rewritable non-volatile memory module has a plurality of physical erasing units. The memory control circuit unit includes a host interface, a memory interface and a memory management circuit. The host interface is configured to couple to a host system, the memory interface is configured to couple to the rewritable non-volatile memory module, and the memory management circuit is coupled to the host interface and the memory interface. The memory management circuit is configured to associate the physical erasing units at least with a data area or a spare area, configure a plurality of logical addresses for mapping to the physical erasing units, and obtain a garbage collection threshold based on a plurality of valid logical addresses among the logical addresses, wherein the physical erasing units mapping to the valid logical address are associated with the data area. The memory management circuit is further configured to perform a garbage collection operation on the data area when the number of the physical erasing units associated with the data area is no less than the garbage collection threshold.

An exemplary embodiment of the invention provides a memory storage apparatus, which includes a connection interface unit, a rewritable non-volatile memory module and a memory control circuit unit. The connection interface unit is configured to couple to a host system. The rewritable non-volatile memory module includes a plurality of physical erasing units. The memory control circuit unit is coupled to the connection interface unit and the rewritable non-volatile memory module. The memory control circuit unit is configured to associate the physical erasing units at least with a data area or a spare area, configure a plurality of logical addresses for mapping to the physical erasing units, and obtain a garbage collection threshold based on a plurality of valid logical addresses among the logical addresses, wherein the physical erasing units mapping to the valid logical address are associated with the data area. The memory control circuit unit is further configured to perform a garbage collection operation on the data area when the number of the physical erasing units associated with the data area is no less than the garbage collection threshold.

Based on the above, the memory management method, the memory control circuit unit and the memory storage apparatus according to the exemplary embodiments of the invention are capable of dynamically adjusting the garbage collection operation activated on the physical erasing units of the data area according to an effective usage of the logical addresses of the rewritable non-volatile memory module. As a result, the performance of executing the sequential write command may be prevented from influence by the garbage collection operation executed each time when the host system only stores data to some of the logical addresses.

To make the above features and advantages of the disclosure more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a host system, a memory storage apparatus and an input/output (I/O) device according to an exemplary embodiment.

FIG. 2 is a schematic diagram illustrating a host system, a memory storage apparatus and an input/output (I/O) device according to another exemplary embodiment.

FIG. 3 is a schematic diagram illustrating a host system and a memory storage apparatus according to another exemplary embodiment.

FIG. 4 is a schematic block diagram illustrating a host system and a memory storage apparatus according to an exemplary embodiment.

FIG. 5 is a schematic block diagram illustrating a memory control circuit unit according to an exemplary embodiment.

FIG. 6 and FIG. 7 are schematic diagrams illustrating management of the physical erasing units according to an exemplary embodiment.

FIG. 8 is a flowchart illustrating a memory management method according to an exemplary embodiment.

FIG. 9 is a flowchart illustrating how to record a count value corresponding to valid logical addresses according to an exemplary embodiment.

FIG. 10 is a schematic diagram of logical address groups according to another exemplary embodiment.

FIG. 11 is a flowchart illustrating how to record a count value corresponding to valid logical addresses according to another exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

In general, a memory storage apparatus (a.k.a. a memory storage system) includes a rewritable non-volatile memory module and a controller (a.k.a. a control circuit unit). The memory storage apparatus is usually configured together with a host system so the host system can write data into the memory storage apparatus or read data from the memory storage apparatus.

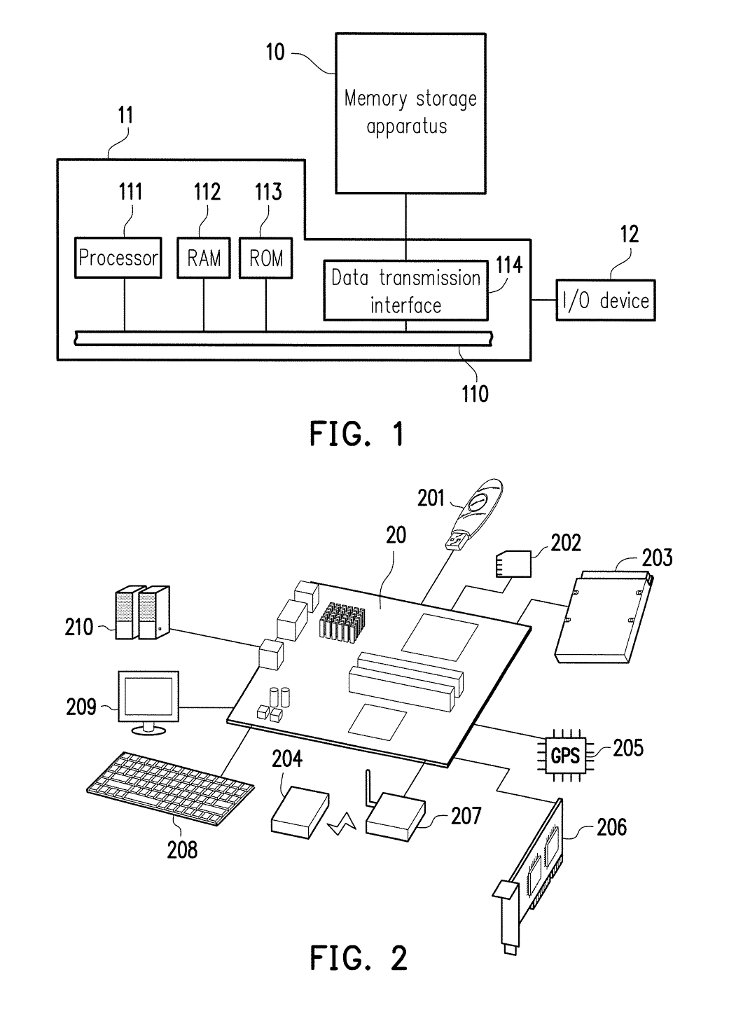

FIG. 1 is a schematic diagram illustrating a host system, a memory storage apparatus and an input/output (I/O) device according to an exemplary embodiment, and FIG. 2 is a schematic diagram illustrating a host system, a memory storage apparatus and an input/output (I/O) device according to another exemplary embodiment.

Referring to FIG. 1 and FIG. 2, a host system 11 generally includes a processor 111, a RAM (random access memory) 112, a ROM (read only memory) 113 and a data transmission interface 114. The processor 111, the RAM 112, the ROM 113 and the data transmission interface 114 are coupled to a system bus 110.

In the present exemplary embodiment, the host system 11 is coupled to a memory storage apparatus 10 through the data transmission interface 114. For example, the host system 11 can write data into the memory storage apparatus 10 or read data from the memory storage apparatus 10 via the data transmission interface 114. Further, the host system 11 is coupled to an I/O device 12 via the system bus 110. For example, the host system 11 can transmit output signals to the I/O device 12 or receive input signals from the I/O device 12 via the system bus 110.

In the present exemplary embodiment, the processor 111, the RAM 112, the ROM 113 and the data transmission interface 114 may be disposed on a main board 20 of the host system 11. The number of the data transmission interface 114 may be one or more. Through the data transmission interface 114, the main board 20 may be coupled to the memory storage apparatus 10 in a wired manner or a wireless manner. The memory storage apparatus 10 may be, for example, a flash drive 201, a memory card 202, a SSD (Solid State Drive) 203 or a wireless memory storage apparatus 204. The wireless memory storage apparatus 204 may be, for example, a memory storage apparatus based on various wireless communication technologies, such as a NFC (Near Field Communication Storage) memory storage apparatus, a WiFi (Wireless Fidelity) memory storage apparatus, a Bluetooth memory storage apparatus, a BLE (Bluetooth low energy) memory storage apparatus (e.g., iBeacon). Further, the main board 20 may also be coupled to various I/O devices including a GPS (Global Positioning System) module 205, a network interface card 206, a wireless transmission device 207, a keyboard 208, a monitor 209 and a speaker 210 through the system bus 110. For example, in an exemplary embodiment, the main board 20 can access the wireless memory storage apparatus 204 via the wireless transmission device 207.

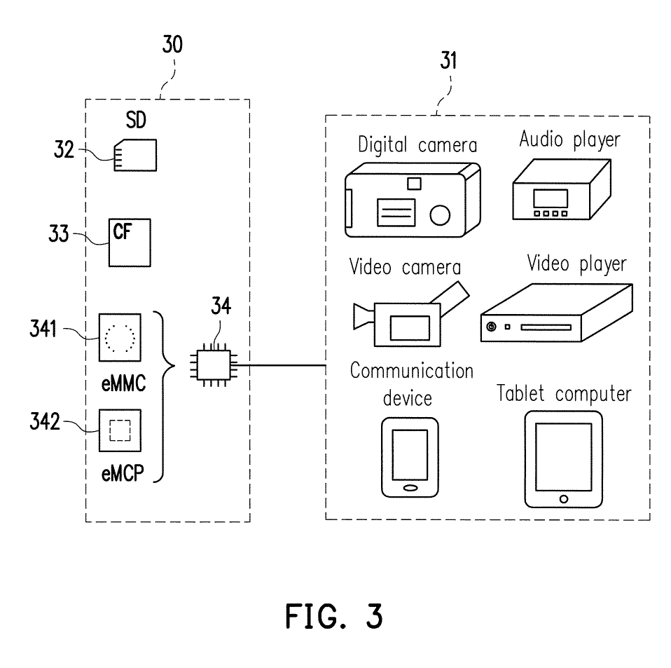

In an exemplary embodiment, aforementioned host system may be any system capable of substantially cooperating with the memory storage apparatus for storing data. Although the host system is illustrated as a computer system in the foregoing exemplary embodiment, nonetheless, FIG. 3 is a schematic diagram illustrating a host system and a memory storage apparatus according to another exemplary embodiment. Referring to FIG. 3, in another exemplary embodiment, a host system 31 may also be a system including a digital camera, a video camera, a communication device, an audio player, a video player or a tablet computer, whereas a memory storage apparatus 30 may be various non-volatile memory storage apparatuses used by the host system, such as a SD card 32, a CF card 33 or an embedded storage device 34. The embedded storage device 34 includes various embedded storage devices capable of directly coupling a memory module onto a substrate of the host system, such as an eMMC (embedded MMC) 341 and/or an eMCP (embedded Multi Chip Package) 342.

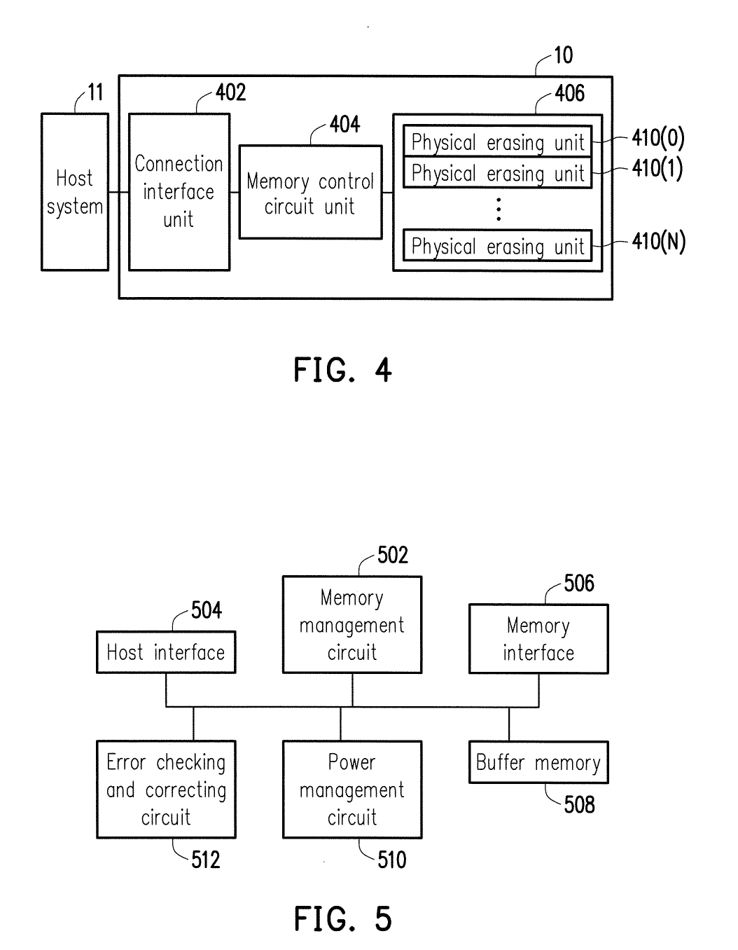

FIG. 4 is a schematic block diagram illustrating a host system and a memory storage apparatus according to an exemplary embodiment.

Referring to FIG. 4, the memory storage apparatus 10 includes a connection interface unit 402, a memory control circuit unit 404 and a rewritable non-volatile memory module 406.

In the present exemplary embodiment, the connection interface unit 402 is compatible with a SATA (Serial Advanced Technology Attachment) standard. Nevertheless, it should be understood that the invention is not limited to the above. The connection interface unit 402 may also be compatible to a SD (Secure Digital) interface standard, a PATA (Parallel Advanced Technology Attachment) standard, an IEEE (Institute of Electrical and Electronic Engineers) 1394 standard, a PCI Express (Peripheral Component Interconnect Express) interface standard, a USB (Universal Serial Bus) standard, a UHS-I (Ultra High Speed-I) interface standard, a UHS-II (Ultra High Speed-II) interface standard, a MS (Memory Stick) interface standard, a Multi-Chip Package interface standard, a MMC (Multi Media Card) interface standard, an eMMC (Embedded Multimedia Card) interface standard, a UFS (Universal Flash Storage) interface standard, an eMCP (embedded Multi Chip Package) interface standard, a CF (Compact Flash) interface standard, an IDE (Integrated Device Electronics) interface standard or other suitable standards. In the present exemplary embodiment, the connection interface unit 402 and the memory control circuit unit 404 may be packaged into one chip, or the connection interface unit 402 is distributed outside of a chip containing the memory control circuit unit.

The memory control circuit unit 404 is configured to execute a plurality of logic gates or control commands which are implemented in a hardware form or in a firmware form and perform operations of writing, reading or erasing data in the rewritable non-volatile memory storage module 406 according to the commands of the host system 11.

The rewritable non-volatile memory module 406 is coupled to the memory control circuit unit 404 and configured to store data written from the host system 11.

The rewritable non-volatile memory storage module 406 includes physical erasing units 410(0) to 410(N). For example, the physical erasing units 410(0) to 410(N) may belong to the same memory die or belong to different memory dies. Each physical erasing unit has a plurality of physical programming units, and the physical programming units of the same physical erasing unit may be written separately and erased simultaneously. Nevertheless, it should be understood that the invention is not limited to the above. Each physical erasing unit may be constituted by 64 physical programming units, 256 physical programming units or any number of the physical programming units.

More specifically, the physical erasing unit is a minimum unit for erasing. Namely, each physical erasing unit contains the least number of memory cells to be erased together. The physical programming unit is the minimum unit for programming. That is, the physical programming unit is the minimum unit for writing data. Each physical programming unit usually includes a data bit area and a redundant bit area.

The data bit area having multiple physical access addresses is used to store user data, and the redundant bit area is used to store system data (e.g., control information and error checking and correcting code). In the present exemplary embodiment, each data bit area of the physical programming unit contains 8 physical access addresses, and the size of each physical access address is 512 byte. However, in other exemplary embodiments, the data bit area may also contain more or less physical access addresses, and the number and size of the physical access addresses are not limited by the invention. For example, in an exemplary embodiment, the physical erasing unit is a physical block, and the physical programming unit is a physical page or a physical sector, but the invention is not limited thereto.

In the present exemplary embodiment, the rewritable non-volatile memory module 406 is a SLC (Single Level Cell) NAND flash memory module (i.e., a flash memory module capable of storing one data bit in one memory cell). However, the invention is not limited to the above. The rewritable non-volatile memory module 406 may also be a MLC (Multi Level Cell) NAND flash memory module, (i.e., a flash memory module capable of storing two data bits in one memory cell), a TLC (Trinary Level Cell) NAND flash memory module (i.e., a flash memory module capable of storing three data bits in one memory cell), other flash memory modules or any memory module having the same features.

FIG. 5 is a schematic block diagram illustrating a memory control circuit unit according to an exemplary embodiment.

Referring to FIG. 5, the memory control circuit unit 404 includes a memory management circuit 502, a host interface 504 and a memory interface 506.

The memory management circuit 502 is configured to control overall operations of the memory control circuit unit 404. Specifically, the memory management circuit 502 has a plurality of control commands and the control commands are executed to perform various operations such as writing, reading and erasing data during operation of the memory storage apparatus 10.

In the present exemplary embodiment, the control commands of the memory management circuit 502 are implemented in a firmware form. For instance, the memory management circuit 502 has a microprocessor unit (not illustrated) and a ROM (not illustrated), and the control commands are burned into the ROM. During operation of the memory storage apparatus 10, the control commands are executed by the microprocessor to perform operations of writing, reading or erasing data.

In another exemplary embodiment of the invention, the control commands of the memory management circuit 502 may also be stored, in form of program codes, into a specific area (e.g., a system area in the memory module exclusively for storing the system data) of the rewritable non-volatile memory module 406. In addition, the memory management circuit 502 has a microprocessor unit (not illustrated), the read only memory (not illustrated) and a random access memory (not illustrated). Especially, the ROM has an activate code, which is executed by the microprocessor unit to load the control commands stored in the rewritable non-volatile memory module 406 to the RAM of the memory management circuit 502 when the memory control circuit unit 404 is enabled. Then, the control commands are executed by the microprocessor unit to perform operations of writing, reading or erasing data.

Further, in another exemplary embodiment of the invention, the control commands of the memory management circuit 502 may also be implemented in a form of hardware. For example, the memory management circuit 502 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory management circuit is configured to manage the physical erasing units of the rewritable non-volatile memory module 406; the memory writing circuit is configured to give a write command to the rewritable non-volatile memory module 406 in order to write data into the rewritable non-volatile memory module 406; the memory reading circuit is configured to give a read command to the rewritable non-volatile memory module 406 in order to read data from the rewritable non-volatile memory module 406; the memory erasing circuit is configured to give an erase command to the rewritable non-volatile memory module 406 in order to erase data from the rewritable non-volatile memory module 406; and The data processing circuit is configured to process both the data to be written into the rewritable non-volatile memory module 406 and the data read from the rewritable non-volatile memory module 406.

The host interface 504 is coupled to the memory management circuit 502 and configured to couple to the connection interface unit 402, so as to receive and identify commands and data sent from the host system 11. In other words, the commands and data transmitted by the host system 11 are transmitted to the memory management circuit 502 via the host interface 504. In the present exemplary embodiment, the host interface 504 is compatible with the SATA standard. However, it should be understood that the present invention is not limited thereto, and the host interface 504 may also be compatible with a PATA standard, an IEEE 1394 standard, a PCI Express standard, a USB standard, a UHS-I standard, a UHS-II standard, a SD standard, a MS standard, a MMC standard, a CF standard, an IDE standard, or other suitable standards for data transmission.

The memory interface 506 is coupled to the memory management circuit 502 and configured to access the rewritable non-volatile memory module 406. In other words, data to be written into the rewritable non-volatile memory module 406 is converted into a format acceptable by the rewritable non-volatile memory module 406 via the memory interface 506.

In an exemplary embodiment, the memory control circuit unit 404 further includes a buffer memory 508, a power management circuit 510 and an error checking and correcting circuit 512.

The buffer memory 508 is coupled to the memory management circuit 502 and configured to temporarily store data and commands from the host system 11 or data from the rewritable non-volatile memory module 406.

The power management unit 510 is coupled to the memory management circuit 502 and configured to control power of the memory storage apparatus 10.

The error checking and correcting circuit 512 is coupled to the memory management circuit 502 and configured to execute an error checking and correcting procedure to ensure the data integrity. Specifically, when the memory management circuit 502 receives a write command from the host system 11, the error checking and correcting circuit 512 generates an ECC code (Error Checking and Correcting Code) for the data corresponding to the write command, and the memory management circuit 502 writes the data and the ECC code corresponding to the write command into the rewritable non-volatile memory module 406. Subsequently, when the memory management circuit 502 reads the data from the rewritable non-volatile memory module 406, the error checking and correcting code corresponding to the data is also read, and the error checking and correcting circuit 512 may execute the error checking and correcting procedure for the read data according to the error checking and correcting code.

In the present exemplary embodiment, a low density parity code (LDPC) is implemented by the error checking and correcting circuit 512. However, in another exemplary embodiment, the error checking and correcting circuit 512 may also be implemented by encoding/decoding algorithms including a BCH code, a convolutional code, a turbo code, a bit flipping, etc.

Specifically, the memory management circuit 502 generates an error correction code frame (ECC frame) according to the received data and the corresponding error checking and correcting code (a.k.a. an error correction code) and writes the ECC frame into the rewritable non-volatile memory module 406. Then, when the memory management circuit 502 reads data from the rewritable non-volatile memory module 406, the error checking and correcting circuit 512 can verify the correctness of the read data according to the error correction code in the ECC frame.

In the following description, the operations executed by the memory management circuit 502, the host interface 504, the memory interface 506, the buffer memory 508, the power management circuit 510 and the error checking and correcting circuit 512 may also be referred to as being executed by the memory control circuit unit 404.

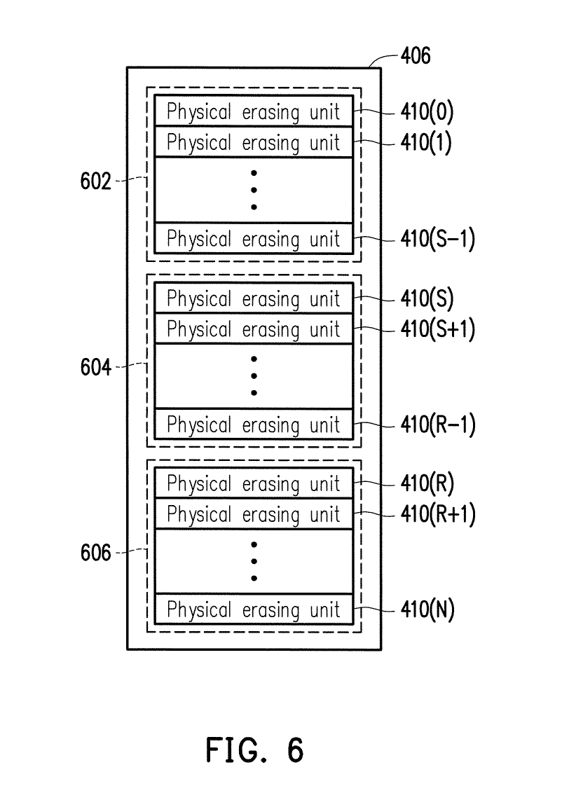

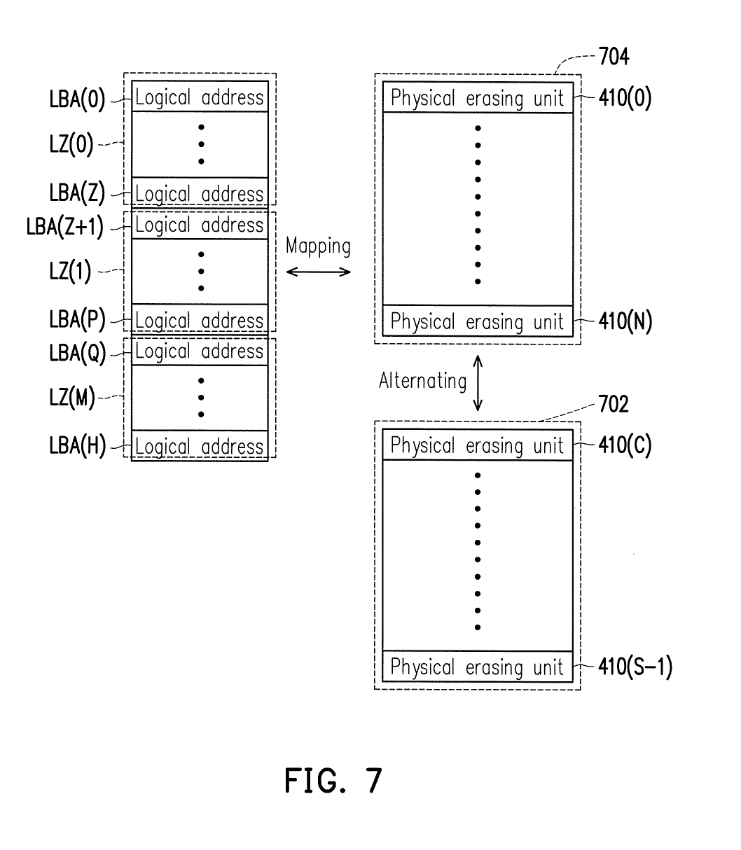

FIG. 6 and FIG. 7 are schematic diagrams illustrating management of the physical erasing units according to an exemplary embodiment.

It should be understood that terms, such as “get”, “retrieve”, “group”, “divide”, “associate” and so forth, are logical concepts which describe operations in the physical erasing units of the rewritable non-volatile memory module 406. In other words, the physical erasing units of the rewritable non-volatile memory module are logically operated so actual positions of the physical units of the rewritable non-volatile memory module are not changed.

Referring to FIGS. 6 and 7, in general, before the memory storage apparatus 10 leaves the factory, manufacturers will perform a formatting operation for the memory storage apparatus 10 using a Mass Production tool (MP tool) so as to perform an initialization. For example, the memory management circuit 502 performs the initialization to logically group the physical erasing units 410(0) to 410(N) into a system area 604, a replacement area 606 and a storage area 602.

The physical erasing units logically belonging to the system area 604 are configured to record system data. For example, the system data includes information related to manufacturer and model of the rewritable non-volatile memory module, a number of physical erasing units in the rewritable non-volatile memory module, a number of the physical programming units in each physical erasing unit, and so forth.

The physical erasing units logically belonging to the replacement area 606 are used in a bad physical erasing unit replacement procedure for replacing damaged physical erasing units. More specifically, if the replacement area 606 still includes normal physical erasing units when the physical erasing units in the storage area 602 are damaged, a memory management circuit 502 retrieves the normal physical erasing units from the replacement area 606 for replacing the damaged physical erasing units.

Among the physical erasing units logically belonging to the storage area 602, the empty physical erasing units will be associated with a spare area 702. When receiving the write command and data to be written (a.k.a. the user data) from the host system 11, the memory management circuit 502 retrieves the physical erasing unit from the spare area 702, gives a command sequence for writing the data into the retrieved physical erasing unit and associates the physical erasing unit already written with the user data (hereinafter, also referred to as a first physical erasing unit) with a data area 704. When all the data in the physical erasing unit of the data area 704 becomes invalid data, such physical erasing unit is re-associated with the spare area 702. In other words, the physical erasing units in the spare area 702 will be continuously used in alternate manner for writing the user data.

Given the physical erasing units in the spare area 702 are continuously used in alternate manner for writing the user data, the memory management circuit 502 assigns logical addresses LBA(0) to LBA(H) for mapping to the physical erasing units of the data area 704. In the present exemplary embodiment, the memory management circuit 502 retrieves the physical erasing unit from the spare area 702 for storing a logical address-physical address mapping table, which records a mapping relation between the logical addresses and the physical programming units of the data area.

It is worth mentioning that, the buffer memory 508 is unable to store the mapping table recording the mapping relations of all the logical addresses due to limited capacity. Therefore, in the present exemplary embodiment, the memory management unit 502 can group the logical addresses LBA(0) to LBA(H) into a plurality of logical zones LZ(0) to LZ(M) and configure one logical address-physical address mapping table for each of the logical zones. In particular, when the memory management unit 502 intends to update the mapping relation for one specific logical unit, the logical address-physical address mapping table corresponding to the logical zone to which the logical unit belongs may be loaded into the buffer memory 508 for updating.

In the present exemplary embodiment, the memory management circuit 502 will continuously monitor a number of the physical erasing units associated with the data area 704. Later, if the number of the physical erasing units associated with the data area 704 is no less than a garbage collection threshold, the memory management circuit 502 then performs a garbage collection operation (a.k.a. a valid data merging operation) on the physical erasing units of the data area 704. Specifically, the memory management circuit 502 selects a plurality of physical erasing units from the data area 704 (e.g., the physical erasing unit 410(0) and the physical erasing unit 410(1)), copies valid data on these physical erasing units to the physical erasing unit 410(C) (hereinafter, also referred to as a second physical erasing unit) retrieved from the spare area 702, and then re-associate the physical erasing units not storing the valid data in the data area 704 with the spare area 702.

Especially, in the present exemplary embodiment, the memory management circuit 502 can dynamically adjust the garbage collection threshold according to used logical addresses (a.k.a. valid logical addresses). Here, the so-called used logical addresses or the valid logical addresses refer to the logical addresses that store the valid data for the host system 11 among the logical addresses. For example, when the host system 11 gives a command for storing data into the logical address LBA(0) so that the memory management circuit 502 programs the data into the physical programming units according to the command, the logical address LBA(0) is then regarded as the used logical address or the valid logical address. Later, when the host system 11 gives a command for deleting the data stored on the logical address LBA(0), the logical address LBA(0) is then regarded as an unused logical address.

In an exemplary embodiment, according to a current number of the valid logical addresses, the memory management circuit 502 calculates the number of the physical erasing units enough for storing the data on these logical addresses, and uses the obtained number as the garbage collection threshold. For example, the size of one logical address is 512 byte, the size of one physical programming unit is 4096 byte, and one physical erasing unit has 128 physical programming units (i.e., a capacity of one physical programming unit is 524288 byte). Accordingly, during operation of the memory storage apparatus 10, the memory management circuit 502 may increase a count value corresponding to the valid logical addresses according to the write command given by the host system 11, reduce the count value corresponding to the valid logical address according to the write command given by the host system, and calculate the number of the physical erasing units required for storing the data on the valid logical addresses according the count value corresponding to the valid logical addresses. In other words, when the number of the physical erasing units in the data area 704 is no less than the number of the physical erasing units required for storing the data on the valid logical addresses, the memory management circuit 502 performs the garbage collection operation so as to re-associate the physical erasing units not storing the valid data in the data area 704 with the spare area 702.

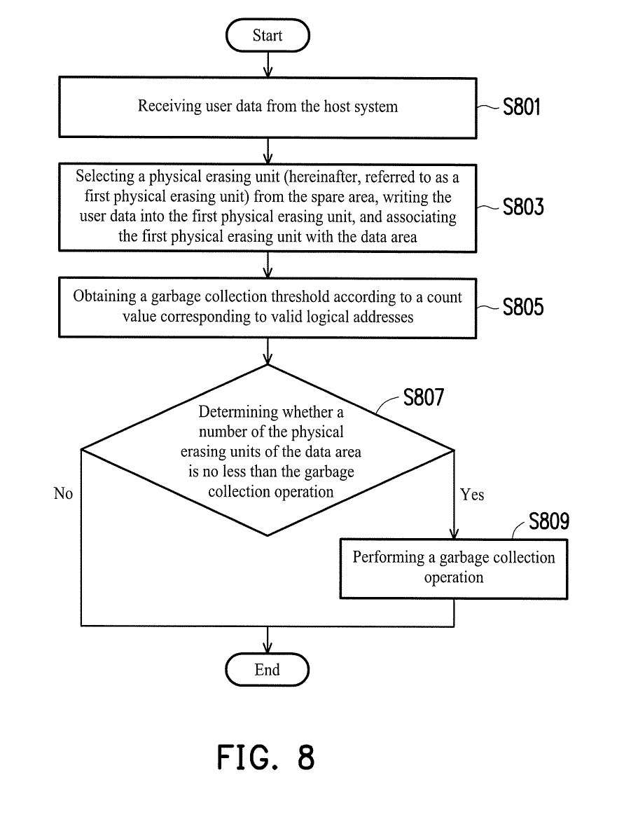

FIG. 8 is a flowchart illustrating a memory management method according to an exemplary embodiment.

In step S801, the memory management circuit 502 receives user data from the host system 11.

In step S803, the memory management circuit 502 selects a physical erasing unit (hereinafter, referred to as a first physical erasing unit) from the spare area 702, writes the user data into the first physical erasing unit, and associates the first physical erasing unit with the data area 704.

In step S805, the memory management circuit 502 obtains a garbage collection threshold according to a count value corresponding to valid logical addresses.

In step S807, the memory management circuit 502 determines whether a number of the physical erasing units of the data area 704 is no less than the garbage collection operation.

If the number of the physical erasing units in the data area 704, in step S809, the memory management circuit 502 performs a garbage collection operation.

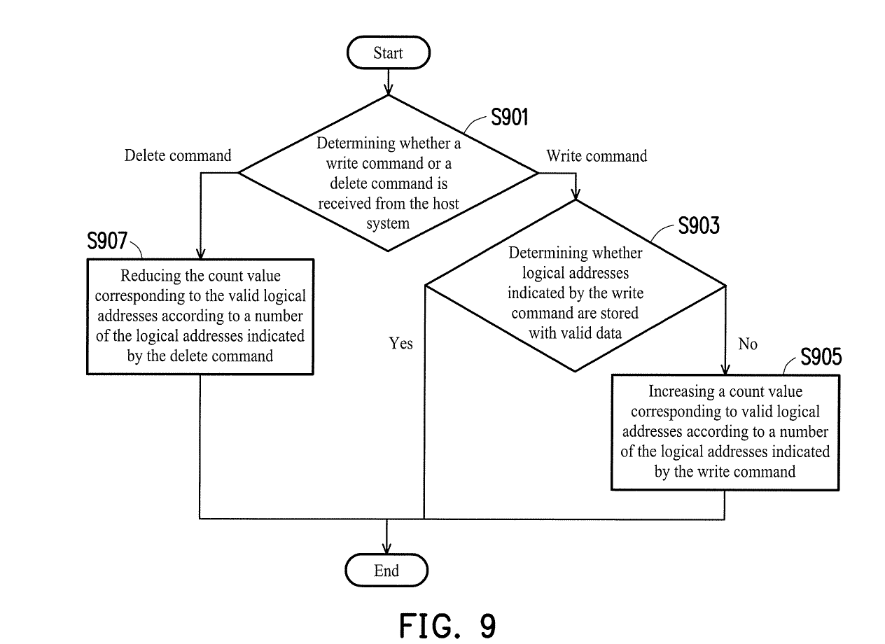

FIG. 9 is a flowchart illustrating how to record a count value corresponding to valid logical addresses according to an exemplary embodiment.

In step S901, the memory management circuit 502 determines whether a write command or a delete command is received from the host system 11.

If the write command is received, in step S903, the memory management circuit 502 determines whether logical addresses indicated by the write command are stored with valid data. If the logical addresses indicated by the write command are not stored with the valid data, in step S905, the memory management circuit 502 increases a count value corresponding to valid logical addresses according to a number of the logical addresses indicated by the write command.

If the delete command is received, in step S907, the memory management circuit 502 reduces the count value corresponding to the valid logical addresses according to a number of the logical addresses indicated by the delete command.

As described above, a maximum number of the physical erasing units in the data area 704 is dynamically adjusted according to the number of the valid logical addresses. Therefore, the physical erasing units of the spare area 702 will not run out due to a random writing on some of the logical addresses. Also, when the host system 11 gives a sequential write command for another part of the logical addresses, the memory management circuit 502 can complete this sequential write command without performing the garbage collection operation so as to prevent write delay.

In the above example, the memory management circuit 502 calculates the count value corresponding to the valid logical addresses according to the number of the valid logical addresses, and dynamically adjusts the garbage collection threshold according to the number of the physical erasing units required for the valid logical addresses. However, the invention is not limited to the above. In another exemplary embodiment, the memory management circuit 502 may also group the logical addresses LBA(0) to LBA(H) into a plurality of logical address groups LC(0) to LC(T), and calculate the count value corresponding to the valid logical addresses according to a size of used logical address groups.

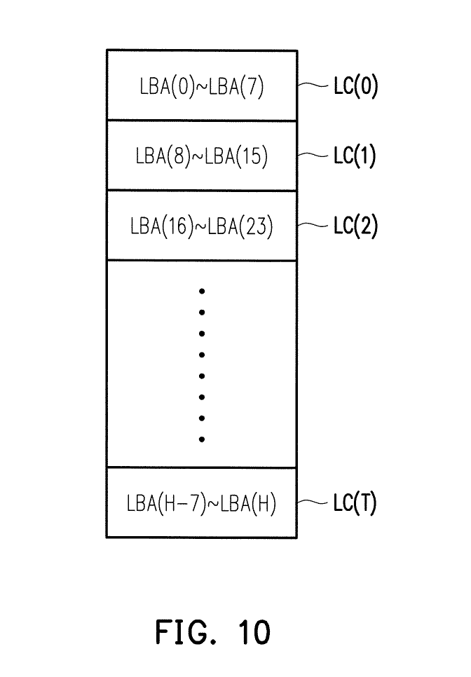

FIG. 10 is a schematic diagram of logical address groups according to another exemplary embodiment.

With reference to FIG. 10, the memory management circuit 502 sequentially groups 8 logical addresses into one logical address group. For example, the logical addresses LBA(0) to LBA(7) are grouped into the logical address group LC(0), the logical addresses LBA(8) to LBA(15) are grouped into the logical address group LC(1), and the rest may be deduced by analogy.

It is assumed that the logical address group LC(0) is marked as the used logical address group when the host system 11 gives a command for writing data into the logical address LBA(0), and the logical address group LC(1) is marked as the used logical address group when the host system 11 gives a command for writing data into the logical address LBA(9). Accordingly, in this example, the memory management circuit 502 calculates the count value corresponding to the valid logical addresses to be a number of the logical addresses in two used logical address groups (i.e., 16 logical addresses).

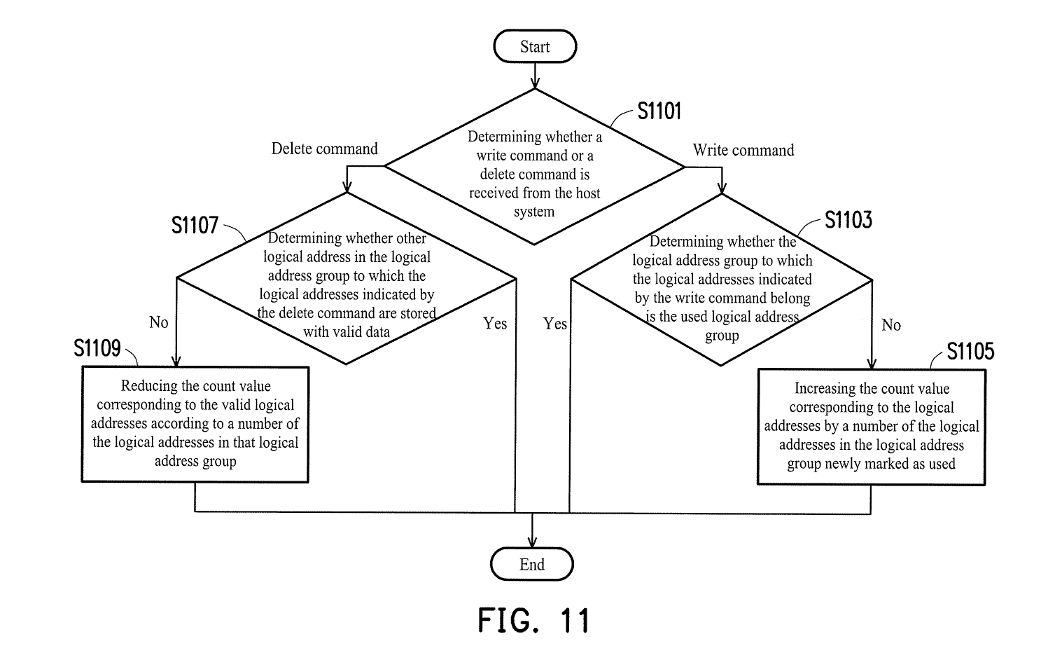

FIG. 11 is a flowchart illustrating how to record a count value corresponding to valid logical addresses according to another exemplary embodiment.

In step S1101, the memory management circuit 502 determines whether a write command or a delete command is received from the host system 11.

If the write command is received, in step S1103, the memory management circuit 502 determines whether the logical address group to which the logical addresses indicated by the write command belong is the used logical address group. If the logical address group to which the logical addresses indicated by the write command belong is not the used logical address group, in step S1105, the memory management circuit 502 increases the count value corresponding to the logical addresses by a number of the logical addresses in the logical address group newly marked as used.

If the delete command is received, in step S1107, the memory management circuit 502 determines whether other logical address in the logical address group to which the logical addresses indicated by the delete command are stored with valid data. If the other logical addresses in the logical address group to which the logical address indicated by the delete command are not stored with the valid data, in step S1109, the memory management circuit 502 reduces the count value corresponding to the valid logical addresses according to a number of the logical addresses in that logical address group.

In summary, the memory management method, the memory control circuit unit and the memory storage apparatus according to the exemplary embodiments of the invention are capable of dynamically adjusting the garbage collection operation activated on the physical erasing units of the data area according to an effective usage of the logical addresses of the rewritable non-volatile memory module. As a result, the performance of executing the sequential write command may be prevented from influence by the garbage collection operation executed each time when the host system only stores data to some of the logical addresses.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A memory managing method for a rewritable non-volatile memory module, the rewritable non-volatile memory module having a plurality of physical erasing units, the memory management method comprising:
associating each of the physical erasing units at least with a data area or a spare area;
configuring a plurality of logical addresses for mapping to the physical erasing units,
calculating a garbage collection threshold based on a capacity of a plurality of valid logical addresses among the logical addresses, wherein the physical erasing units mapping to the valid logical address are associated with the data area;
determining whether a number of the physical erasing units associated with data area is no less than the garbage collection threshold calculated based on the capacity of a plurality of valid logical addresses; and
performing a garbage collection operation on the physical erasing units associated with the data area if the number of the physical erasing units associated with data area is no less than the garbage collection threshold.

2. The memory management method according to claim 1, further comprising:
receiving a plurality of data from a host system, wherein the plurality of data belong to a plurality of first logical addresses among the logical addresses and the first logical addresses belong to the valid logical addresses;
programming the plurality of data into a first physical erasing unit among the physical erasing units; and
associating the first physical erasing unit with the data area.

3. The memory management method according to claim 1, wherein the step of calculating the garbage collection threshold based on the capacity of the valid logical addresses among the logical addresses comprises:
generating the garbage collection threshold based on a capacity of the valid logical addresses and a capacity of each of the physical erasing units.

4. The memory management method according to claim 1, further comprising:
grouping the logical addresses into a plurality of logical address groups;
calculating the garbage collection threshold based on a capacity of a plurality of used logical address groups among the logical address groups,
wherein each used logical address group among the used logical address groups comprises at least one valid logical address of the valid logical addresses.

5. (canceled)

6. The memory management method according to claim 1, wherein the step of performing the garbage collection operation on the physical erasing units associated with the data area comprises:
selecting a second physical erasing unit from the spare area, copying all valid data on at least two physical erasing units of the data area to the second physical erasing unit, re-associating the at least two physical erasing units of the data area with the spare area, and associating the second physical erasing units with the data area.

7. A memory control circuit unit for controlling a rewritable non-volatile memory module, the memory control circuit unit comprising:
a host interface, configured to couple to a host system,
a memory interface, configured to couple to a rewritable non-volatile memory module, wherein the rewritable non-volatile memory module has a plurality of physical erasing units; and
a memory management circuit, coupled to the host interface and the memory interface;
wherein the memory management circuit is configured to associate each of the physical erasing units with a data area or a spare area, and configure a plurality of logical addresses for mapping to the physical erasing units,
wherein the memory management circuit is further configured to calculate a garbage collection threshold based on a capacity of a plurality of valid logical addresses among the logical addresses, wherein the physical erasing units mapping to the valid logical address are associated with the data area,
wherein the memory management circuit is further configured to determine whether a number of the physical erasing units associated with data area is no less than the garbage collection threshold calculated based on the capacity of a plurality of valid logical addresses,
wherein the memory management circuit is further configured to perform a garbage collection operation on the physical erasing units associated with the data area if the number of the physical erasing units related to data area is no less than the garbage collection threshold.

8. The memory control circuit unit according to claim 7, wherein the memory management circuit is further configured to receive a plurality of data from the host system, and the plurality of data belong to a plurality of first logical addresses among the logical addresses and the first logical addresses belong to the valid logical addresses,
wherein the memory management circuit is further configured to give a command sequence for programming the plurality of data into a first physical erasing unit among the physical erasing units and associate the first physical erasing unit with the data area.

9. The memory control circuit unit according to claim 7, wherein in the operation of calculating the garbage collection threshold based on the capacity of the valid logical addresses among the logical addresses, the memory management circuit is further configured to generate the garbage collection threshold based on a capacity of the valid logical addresses and a [[size]]capacity of each of the physical erasing units.

10. The memory control circuit unit according to claim 7, wherein the memory management circuit is further configured to group the logical addresses into a plurality of logical address groups, and calculate the garbage collection threshold based on a capacity of a plurality of used logical address groups among the logical address groups,
wherein each used logical address group among the used logical address groups comprises at least one valid logical address of the valid logical addresses.

11. (canceled)

12. The memory control circuit unit according to claim 7, wherein in the operation of performing the garbage collection operation on the physical erasing units associated with the data area, the memory management circuit selects a second physical erasing unit from the spare area, copies all valid data on at least two physical erasing units of the data area to the second physical erasing unit, re-associates the at least two physical erasing units of the data area with the spare area, associates the second physical erasing units with the data area.

13. A memory storage apparatus, comprising:
a connector, configured to couple to a host system;
a rewritable non-volatile memory module, having a plurality of physical erasing units; and
a memory control circuit unit, coupled to the connector and the rewritable non-volatile memory module,
wherein the memory control circuit unit is configured to associate each of the physical erasing units with a data area or a spare area, and configure a plurality of logical addresses for mapping to the physical erasing units,
wherein the memory control circuit unit is further configured to calculate a garbage collection threshold based on a capacity of a plurality of valid logical addresses among the logical addresses, wherein the physical erasing units mapping to the valid logical address are associated with the data area,
wherein the memory control circuit unit is further configured to determine whether a number of the physical erasing units associated with data area is no less than the garbage collection threshold calculated based on the capacity of a plurality of valid logical addresses,
wherein the memory control circuit unit is further configured to perform a garbage collection operation on the physical erasing units associated with the data area if the number of the physical erasing units associated with the data area is no less than the garbage collection threshold.

14. The memory storage apparatus according to claim 13, wherein the memory control circuit unit is further configured to receive a plurality of data from the host system, wherein the plurality of data belong to a plurality of first logical addresses among the logical addresses and the first logical addresses belong to the valid logical addresses,
wherein the memory control circuit unit is further configured to program the plurality of data into a first physical erasing unit among the physical erasing units and associate the first physical erasing unit with the data area.

15. The memory storage apparatus according to claim 13, wherein in the operation of calculating the garbage collection threshold based on the capacity of the valid logical addresses among the logical addresses, the memory control circuit unit is further configured to generate the garbage collection threshold based on a capacity of the valid logical addresses and a capacity of each of the physical erasing units.

16. The memory storage apparatus according to claim 13, wherein the memory control circuit unit is further configured to group the logical addresses into a plurality of logical address groups, and calculate the garbage collection threshold based on a capacity of a plurality of used logical address groups among the logical address groups,
wherein each used logical address group among the used logical address groups comprises at least one valid logical address of the valid logical addresses.

17. (canceled)

18. The memory storage apparatus according to claim 7, wherein in the operation of performing the garbage collection operation on the physical erasing units associated with the data area, the memory control circuit unit selects a second physical erasing unit from the spare area, copies all valid data on at least two physical erasing units of the data area to the second physical erasing unit, re-associates the at least two physical erasing units of the data area with the spare area, associates the second physical erasing units with the data area.
